(19) United States
(12) Patent Application Publication
(10) Pub. No.: US 2025/0266508 A1
(43) Pub. Date: Aug. 21, 2025

(54) RECHARGEABLE BATTERY AND ELECTRODE ASSEMBLY THEREOF

(71) Applicant: SAMSUNG SDI CO., LTD., Yongin-si (KR)

(72) Inventors: Hiroshi Seino, Yongin-si (KR); Jeongchull Ahn, Yongin-si (KR); Sanghyun Kim, Yongin-si (KR); Sunyang Hong, Yongin-si (KR)

(21) Appl. No.: 19/011,785

(22) Filed: Jan. 7, 2025

(30) Foreign Application Priority Data
Feb. 20, 2024 (KR) 10-2024-0024457

(51) Int. Cl. H01M 10/42; H01M 10/04; H01M 50/107; H01M 50/474; H01M 50/486; H01M 50/489

(52) U.S. Cl. CPC H01M 10/4235; H01M 10/0431; H01M 50/474; H01M 50/486; H01M 50/489; H01M 50/107

(57) ABSTRACT

An electrode assembly includes a first electrode, a first separator on the first electrode, a second electrode on the first separator, the second electrode including an outer uncoated portion, a second separator on the second electrode, the first electrode, the first separator, the second electrode, and the second separator being wound into a jelly roll shape, and the outer uncoated portion of the second electrode being at an outermost turn of the jelly roll shape, and a swelling tape attached to at least one of opposite surfaces of the outer uncoated portion of the second electrode, the swelling tape including swelling particles.

### CROSS-REFERENCE TO RELATED APPLICATION

This application claims priority to and the benefit of Korean Patent Application No. 10-2024-0024457, filed at the Korean Intellectual Property Office on Feb. 20, 2024, the entire contents of which are incorporated herein by reference.

### BACKGROUND

### 1. Field

The present disclosure relates to a rechargeable battery and an electrode assembly thereof, and more specifically, to a rechargeable battery and an electrode assembly thereof to which a swelling tape is applied.

### 2. Description of the Related Art

Unlike a primary battery, a rechargeable battery is a battery that repeatedly performs charging and discharging. A small-capacity rechargeable battery may be used in a portable small electronic device such as a mobile phone, a laptop computer, or a camcorder. A large-capacity and high-density rechargeable battery may be used as a power source for driving a motor of a hybrid vehicle or an electric vehicle or an energy storage device of the hybrid vehicle or the electric vehicle.

The rechargeable battery may include an electrode assembly for charging and discharging a current, a case or a pouch for accommodating the electrode assembly and an electrolyte, and an electrode terminal connected to the electrode assembly to draw the electrode assembly out to the outside of the case or the pouch. The electrode assembly may be a jelly roll type formed by winding an electrode plate and a separator or a stack type formed by stacking an electrode plate and a separator.

### SUMMARY

An electrode assembly according to embodiments of the present disclosure includes a first electrode, a first separator, a second electrode, and a second separator that are formed by being wound in a stacked state. The second electrode includes: an uncoated portion that is formed at an outermost turn; and a swelling tape that is attached to at least one of both surfaces of the uncoated portion and includes a swelling particle.

The swelling tape may be provided at one position or a plurality of positions along a wound circumferential direction.

The swelling tape may include a substrate layer and an adhesive layer, and the swelling particle may be included in the adhesive layer.

The substrate layer may be in contact with the first separator, and the adhesive layer and the swelling particle may be attached to the uncoated portion.

The swelling tape may include a substrate layer and an adhesive layer, and the swelling particle may be included in the substrate layer.

The substrate layer and the swelling particle may be in contact with the first separator, and the adhesive layer may be attached to the uncoated portion.

The swelling tape may include a substrate layer and an adhesive layer, and may further include a swelling particle film coated on a surface of the adhesive layer.

The substrate layer may be in contact with the first separator, and the swelling particle film may be attached to the uncoated portion.

The swelling tape may include a substrate layer and an adhesive layer, and may further include a swelling particle film coated on a surface of the substrate layer.

The swelling particle film may be in contact with the first separator, and the adhesive layer may be attached to the uncoated portion.

The swelling tape may include a substrate layer and an adhesive layer, and may further include a swelling particle film coated on a surface of the adhesive layer and another adhesive layer further formed on the swelling particle film.

The substrate layer may be in contact with the first separator, and the adhesive layer may be attached to the substrate layer and the other adhesive layer may be attached to the uncoated portion.

The swelling tape may include a substrate layer and an adhesive layer, and may further include a swelling particle film coated on a surface of the substrate layer and another substrate layer further formed on the swelling particle film.

The other substrate layer may be in contact with the first separator and the substrate layer may be attached to the adhesive layer, and the adhesive layer may be attached to the uncoated portion.

The swelling tape may include a substrate layer and an adhesive layer, and the substrate layer may be formed of one of PP, PE, PET, PI, PVDF, and urethane.

The adhesive layer may be formed of one of an acryl adhesive, a rubber adhesive, a silicon adhesive, and a polyolefin hot melt adhesive.

The swelling particle may be formed of one of an acryl polymer, a urethane polymer, and a silicon polymer.

The swelling tape may include a substrate layer and an adhesive layer, and the swelling particle may have a size of 1-40 μm and may be included in 5-60 vol % of the entire adhesive layer.

A thickness of the adhesive layer may be 10-71 μm.

A rechargeable battery according to embodiments of the present disclosure includes the electrode assembly, and a case that includes the electrode assembly. The uncoated portion is electrically connected to an inner surface of the case.

### BRIEF DESCRIPTION OF THE DRAWINGS

Features will become apparent to those of skill in the art by describing in detail exemplary embodiments with reference to the attached drawings, in which:

FIG. 1 is a sectional perspective view of a rechargeable battery according to a first embodiment of the present disclosure.

FIG. 2 is an exploded cross-sectional view of an electrode assembly applied to FIG. 1.

FIG. 3 is a perspective view of an electrode assembly formed of the electrodes and separators of FIG. 2.

FIG. 4 is a horizontal cross-sectional view of the rechargeable battery where the electrode assembly of FIG. 3 is inserted into a case.

FIG. 5 is a cross-sectional view showing a stacking relationship between a separator, a swelling tape, an uncoated portion, and the case of FIG. 4 enlarged in a planar state.

FIG. 6 is a cross-sectional view showing a stacking relationship between a separator, a swelling tape, an uncoated portion, and a case of a rechargeable battery according to a second embodiment of the present disclosure enlarged in a planar state.

FIG. 7 is a cross-sectional view showing a stacking relationship between a separator, a swelling tape, an uncoated portion, and a case of a rechargeable battery according to a third embodiment of the present disclosure enlarged in a planar state.

FIG. 8 is a cross-sectional view showing a stacking relationship between a separator, a swelling tape, an uncoated portion, and a case of a rechargeable battery according to a fourth embodiment of the present disclosure enlarged in a planar state.

FIG. 9 is a cross-sectional view showing a stacking relationship between a separator, a swelling tape, an uncoated portion, and a case of a rechargeable battery according to a fifth embodiment of the present disclosure enlarged in a planar state.

FIG. 10 is a cross-sectional view showing a stacking relationship between a separator, a swelling tape, an uncoated portion, and a case of a rechargeable battery according to a sixth embodiment of the present disclosure enlarged in a planar state.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

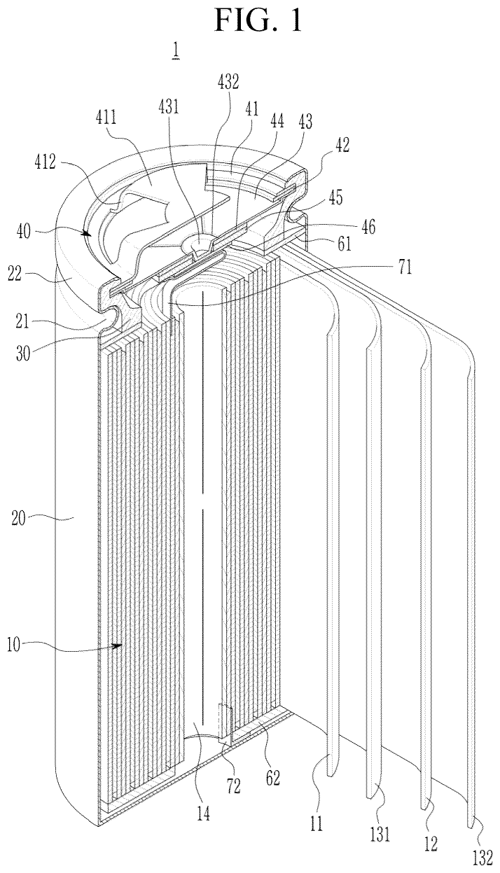

FIG. 1 is a sectional perspective view of a rechargeable battery according to an embodiment of the present disclosure.

Referring to FIG. 1, a rechargeable battery 1 according to an embodiment may include an electrode assembly 10 that performs charging and discharging, a case 20 accommodating the electrode assembly 10, and a cap assembly 40 coupled to an opening of the case 20 through a gasket 30.

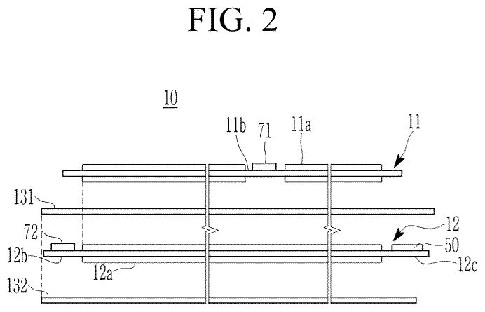

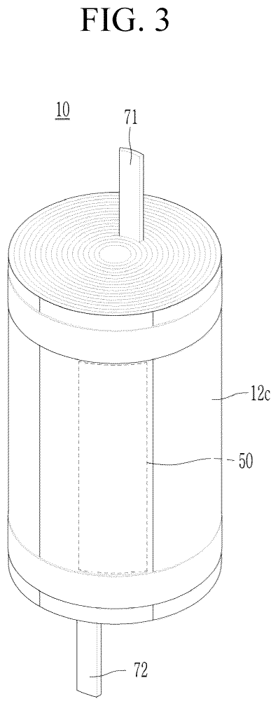

FIG. 2 is an exploded schematic cross-sectional view of the electrode assembly 10 (of FIG. 1) in an unrolled state, and FIG. 3 is a perspective view of the electrode assembly 10 formed of the electrodes and separators of FIG. 2.

Referring to FIGS. 1 to 3, the electrode assembly 10 may include a first electrode 11 (e.g., a cathode), a first separator 131, a second electrode 12 (e.g., an anode), and a second separator 132 that are sequentially disposed. The electrode assembly 10 may be formed by winding the first electrode 11, the first separator 131, the second electrode 12, and the second separator 132 in a jelly roll state. The first and second separators 131 and 132 may act as an insulator between the wound first and second electrodes 11 and 12.

For example, referring to FIG. 1, the first electrode 11 may be electrically connected to the cap assembly 40 through a first tab 71, and the second electrode 12 may be electrically connected to the case 20 through a second tab 72. In another example, the first electrode 11 may be connected to the case through the first tab, and the second electrode 12 may be connected to the cap assembly through the second tab.

The electrode assembly 10 may be formed as, e.g., a cylinder. The cylindrical electrode assembly 10 may include a center pin 14 at a center thereof. The center pin 14 may be formed of a material with a higher strength than that of the electrode assembly 10 to maintain the electrode assembly 10 in a cylindrical shape and discharge an internal gas generated by charging and discharging to an intermediate path.

The first electrode 11 may include first coating portions 11a of regions where active materials are coated on opposite surfaces (e.g., both surfaces) of a first current collector formed of a metal foil (e.g., an aluminum foil), and a first uncoated portion 11b (i.e., a region where the first current collector is exposed because an active material is not coated thereon) between the first coating portions 11a in a length direction of the first current collector. The first tab 71 may be connected to the first uncoated portion 11b.

The second electrode 12 may include second coating portions 12a of regions where active materials are coated on opposite surfaces of a second current collector formed of a metal foil (e.g., a copper foil), and a second uncoated portion 12b (i.e., a region where the second current collector is exposed because an active material is not coated thereon) between the second coating portions 12a. The second tab 72 may be connected to the second uncoated portion 12b.

Referring back to FIG. 1, in the jelly roll state, the first tab 71 connected to the first uncoated portion 11b of the first electrode 11 may extend through a first insulating member 61 to be electrically connected to the cap assembly 40, and the second tab 72 connected to the second uncoated portion 12b of the second electrode 12 may extend through a second insulating member 62 to be electrically connected to the case 20. The first insulating member 61 may electrically insulate an upper end of the electrode assembly 10 from the cap assembly 40, and the second insulating member 62 may electrically insulate a lower end of the electrode assembly 10 from the case 20.

The case 20 may include an opening at one side so that the electrode assembly 10 is inserted from the outside, and may be formed in a cylindrical shape to accommodate the cylindrical electrode assembly 10. The case 20 may be connected to the second tab 72 by welding to act as a second electrode terminal (e.g., an anode terminal) in the rechargeable battery 1, and may be formed of a conductive metal, e.g., aluminum, an aluminum alloy, a nickel-plated steel, or the like.

The cap assembly 40 may be coupled to the opening of the case 20 through the gasket 30 to be electrically insulated from the case 20 and seal the case 20 accommodating the electrode assembly 10 and an electrolyte. The cap assembly 40 may be electrically connected to the electrode assembly 10 through a current interrupting device (or a current interrupting portion) and the first tab 71. In this case, the first insulating member 61 may accommodate penetration of the first tab 71 therethrough.

The cap assembly 40 may include a cap plate 41, a positive temperature coefficient element (PTC) 42, a vent plate 43, an insulator 44, a middle plate 45, and a sub-plate 46 that are sequentially disposed from the outside toward the inside of the case 20.

The cap plate 41 may be connected to the first tab 71 to act as a first electrode terminal (e.g., a cathode terminal) in the rechargeable battery 1, and may include a protruding portion 411 protruding to the outside of the case 20 and an exhaust port 412 that is opened to a side of the protruding portion 411 to discharge an internal gas.

The current interrupting device in the cap assembly 40 may be formed by the vent plate 43 and the sub-plate 46 that are electrically separated by an insulator 44, and a connection portion that partially connects them. The connection portion may be formed by welding the vent plate 43 and the sub-plate 46. For example, the vent plate 43 that forms one side of the current interrupting device may be installed inside the cap plate 41 to be electrically connected to the sub-plate 46 that forms the other side of the current interrupting device.

In some embodiments, a central portion of the vent plate 43 may include a vent 431 so that the vent 431 is welded to the sub-plate 46, and the vent plate 43 may be separated from the welded sub-plate 46 by an internal pressure. The vent 431 may be damaged under a predetermined pressure condition to release an internal gas generated by charging and discharging and block an electrical connection with the sub-plate 46. For example, the vent 431 may be formed by protruding from the vent plate 43 toward the inside of the case 20. The vent plate 43 may include a notch 432 around the vent 431 guiding a damage of the vent 431. Therefore, if an internal pressure of the case 20 increases due to generation of gas, the notch 432 may be damaged in advance so that the gas is discharged to the outside through the vent plate 43 and the exhaust port 412. Thus, explosion of the rechargeable battery may be prevented.

The sub-plate 46 may face the vent plate 43 to be electrically connected to the vent 431 and the middle plate 45. The middle plate 45 may be spaced apart from the vent plate 43, and may be connected to the vent plate 43 via the insulator 44. The vent 431 may protrude through through-holes of the insulator 44 and the middle plate 45 to be connected to the sub-plate 46.

Therefore, the middle plate 45 may be electrically connected to the vent 431 and the vent plate 43 through the sub-plate 46. In some embodiments, the middle plate 45 may be connected to the first tab 71 by welding, and the first tab 71 may penetrate the first insulating member 61 to be connected to the uncoated portion 11b of the first electrode 11 by welding. As a result, the first tab 71 may be electrically connected to the cap plate 41 by sequentially passing through the middle plate 45, the sub-plate 46, the vent 431, the vent plate 43, and the positive temperature coefficient element 42.

The cap assembly 40 configured as described above may be inserted into the opening of the case 20 through the gasket 30, and then may be fixed to the opening of the case 20 through a crimping process to form the rechargeable battery 1. In this case, the case 20 may form a beading portion 21 recessed into a center of a radial direction of the case 20 at a side of the opening and a clamping portion 22 holding an outer circumference of the cap assembly 40 through the gasket 30.

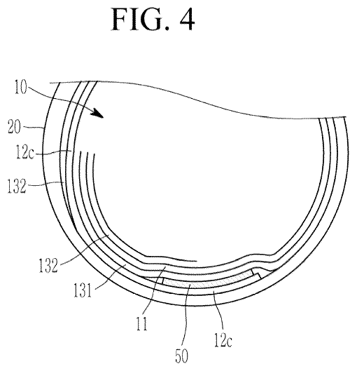

FIG. 4 is a schematic, horizontal, partial cross-sectional view (in a top view) of the electrode assembly 10 (of FIG. 3) in a rolled state (relative to the unrolled state in FIG. 2) inside the case 20.

Referring to FIGS. 2 to 4, in the electrode assembly 10, the second electrode 12 may further include an outer uncoated portion 12c formed at an outermost turn. For example, referring to FIG. 4, the outer uncoated portion 12c may have a predetermined length in an outermost portion of the second electrode 12 (e.g., along a circumferential direction of the electrode assembly 10) that extends beyond an outermost edge of the second separator 132 (while rolled into a jelly roll state). The outer uncoated portion 12c of the second electrode 12 may be in close contact (e.g., direct contact) with an inner surface of the case 20 and may be electrically connected to the inner surface of the case 20 so that an internal resistance of the rechargeable battery 1 is lowered. For example, referring to FIG. 4, the outer uncoated portion 12c may contact the inner surface of the case 20 to enclose the outermost edge of the second separator 132 therebetween.

Referring to FIG. 4, the second electrode 12 may include a swelling tape 50 attached to at least one surface of both surfaces of the outer uncoated portion 12c, e.g., the swelling tape 50 may be between the outer uncoated portion 12c and the first separator 131 when in a jelly roll state (FIG. 4). For example, referring to FIG. 4, the outer uncoated portion 12c may be directly between the swelling tape 50 and the case 20.

For example, referring to FIG. 4, the swelling tape 50 may be provided at one position. In another example, the swelling tape 50 may be at a plurality of positions along a wound circumferential direction of the electrode assembly 10. For example, referring to FIG. 3, the swelling tape 50 may have a width that extends along a majority of a width of the second electrode 12 (e.g., along a height of the electrode assembly 10 oriented along a direction from the first tab 71 to the second tab 72, as shown by the dashed rectangle in FIG. 3).

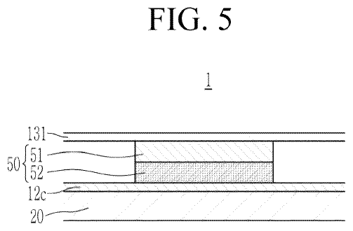

FIG. 5 is a cross-sectional view showing a stacking relationship between the first separator 131, the swelling tape 50, the outer uncoated portion 12c, and the case 20 of FIG. 4 enlarged in a planar state.

Referring to FIG. 5, the swelling tape 50 may include a substrate layer 51 formed of a substrate of the tape and an adhesive layer 52 formed of an adhesive on the substrate layer 51. The swelling particle may be provided at various positions for the substrate layer 51 and the adhesive layer 52 by various methods. For example, referring to FIG. 5, the swelling tape 50 may be completed by mixing the swelling particles with the adhesive to form the adhesive layer 52, and applying the swelling particle mixed with the adhesive (i.e., the adhesive layer 52) to the substrate layer 51 to form the adhesive layer 52 on the substrate layer 51.

In the swelling tape 50, the swelling particle may be included in the adhesive layer 52. Because the swelling particle swells three-dimensionally, a direction in which a swelling effect occurs may be maximized in a thickness direction of the swelling tape 50 (e.g., a radial direction of the electrode assembly 10) by increasing a thickness of the swelling tape 50.

For example, a wrinkle formed by swelling of the substrate layer 51 may spread in a surface direction so that the swelling particle prevents the swelling effect in the thickness direction from being insufficient. Because the swelling particle adjusts an amount of swelling according to the number and a size of the particle, a damage to the substrate layer 51 due to excessive expansion may be prevented.

In the rechargeable battery 1 to which the swelling tape 50 is applied according to an embodiment, the substrate layer 51 may be in contact with the first separator 131, and the adhesive layer 52 with the swelling particle may be attached to the outer uncoated portion 12c of the second electrode 12 (e.g., the adhesive layer 52 with the swelling particle may be between the substrate layer 51 and the outer uncoated portion 12c of the second electrode 12). In this case, the outer uncoated portion 12c may be in close contact (e.g., direct contact) with an inner surface of the case 20 to form an electrical connection (e.g., the outer uncoated portion 12c may be directly between the inner surface of the case 20 and the adhesive layer 52).

Because the swelling particle included in the adhesive layer 52 absorbs the electrolyte to swell within the rechargeable battery 1 of the embodiment, a thickness of the adhesive layer 52 may increase so that an entire thickness of the swelling tape 50 increases. For example, an expansion rate of the swelling tape 50 may be maximized.

The swelling particle may expand by absorbing the electrolyte. In this case, the swelling particle may expand three-dimensional (e.g., in all directions), so that the swelling tape 50 stably secures an increase in the thickness. Therefore, the outer uncoated portion 12c of the second electrode 12 may be in stable contact with the inner surface of the case 20 while receiving a swelling support force of the swelling tape 50. Thus, an internal resistance of the rechargeable battery 1 may be stably reduced.

Any suitable material of the substrate layer 51 may be used, as long as is it is formed of a soft material that may not interfere with expansion of the swelling particle. For example, the substrate layer 51 may be formed of at least one of polypropylene (PP), polyethylene (PE), polyvinyl chloride (PVC), ethylene vinyl acetate (EVA), polyimide (PI), and polyethylene terephthalate (PET). In contrast, a hard material may reduce an amount of swelling by applying a pressure suppressing swelling of the swelling particle. For example, the substrate layer 51 may also be formed of polyvinylidene fluoride (PVDF) or urethane that may swell the substrate layer 51 itself, so that a total amount of swelling of the entire swelling tape 50 may increase.

The adhesive layer 52 may be formed of one of an acryl adhesive, a rubber adhesive, a silicon adhesive, and a hot melt adhesive. A thickness of the adhesive layer 52 may be 10 μm to 71 μm (see Table 1), as measured along a radial direction of the electrode assembly 10 (e.g., FIG. 4) or a direction normal to an interior of the case 20 (e.g., FIG. 5).

The swelling particle may be a polymer, and may be formed of one of an acryl polymer, a urethane polymer, and a silicon polymer. An average particle diameter (d50) of the swelling particle may be 40 μm or less (e.g., 30 μm or less, or 20 μm or less).

The average particle diameter (d50) may be a particle size corresponding to when a cumulative percentage reaches 50%. The average particle diameter (d50) may also be referred to as a medium particle size. For example, the average particle diameter (d50) may mean that for a powder sample with an average particle diameter (d50) of 5 μm, 50% of the particles are larger than 5 μm and 50% of the particles are smaller than 5 μm. The average particle diameter (d50) may represent an average particle size in production and application of a powder material.

In some embodiments, the average particle diameter (d50) of the swelling particle may have a size of 1 μm to 40 μm, and may be included in 5 vol % to 60 vol %, based on the entire (100 vol %) adhesive layer 52. A minimum value of the average particle diameter (d50) may be 1 μm or more, e.g., 5 μm or more (see Table 1).

If the average particle diameter (d50) is large (i.e., if the average particle diameter (d50) exceeds a maximum value of 40 μm), after the substrate layer 51 and the adhesive layer 52 are completed, a dispersion in a thickness of the swelling tape 50 may be greatly affected so that stabilization of a dimension of the rechargeable battery is impaired. If the average particle diameter (d50) is small (i.e., if the average particle diameter (d50) is less than a minimum value of 1 μm), it is necessary to add a large amount of the swelling particle to obtain a desired effect, thereby potentially deteriorating the adhesive strength of the adhesive layer 52 and the mechanical characteristics of the substrate layer 51. If the average particle diameter (d50) is 5 μm to 40 μm, the dispersion in the thickness of the swelling tape 50 may not be large, and the mechanical characteristics of the adhesive layer and the substrate layer may remain stable due to addition of an appropriate amount of the swelling particle.

An additional amount of the swelling particle may be less than or equal to a maximum amount within a range that does not degrade a physical property of the substrate forming the substrate layer 51 and a characteristic of the adhesive forming the adhesive layer 52. If an insulating property is required for the substrate layer 51, it may be required that there is no decrease in a puncture strength. A possibility of securing an adhesive strength and a cohesion of the adhesive may be required.

Although the additional amount of the swelling particle also depends on a size of the swelling particle, the additional amount of the swelling particle may be 60 vol % or less, e.g., 30 vol % or less. The additional amount of the swelling particle may be 5 vol % to 60 vol % (see Table 1). If the additional amount of the swelling particle exceeds 60 vol %, after the substrate layer 51 and the adhesive layer 52 are completed, a dispersion in a thickness of the swelling tape 50 may be greatly affected so that stabilization of a dimension of the rechargeable battery is impaired. If the additional amount of the swelling particle is less than 5 vol %, it may be difficult to obtain a desired swelling effect. If the additional amount of the swelling particle is 5 vol % to 60 vol %, the dispersion in the thickness of the swelling tape 50 may not be large, and may obtain a desired effect.

Hereinafter, various comparative examples and embodiments of the present disclosure will be described. A description of components and configurations similar to those described previously with reference to FIGS. 1-5 will be omitted, and only a description of a configuration that is different from the embodiment in FIGS. 1-5 will be provided.

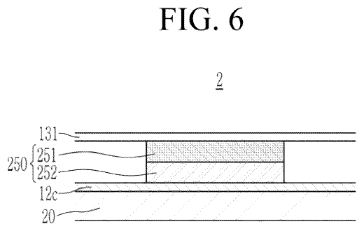

FIG. 6 is a cross-sectional view showing a stacking relationship between the first separator 131, a swelling tape, the outer uncoated portion 12c, and the case 20 of a rechargeable battery 2 according to another embodiment of the present disclosure, enlarged in a planar state.

Referring to FIG. 6, in the rechargeable battery 2, a swelling tape 250 may include a substrate layer 251 and an adhesive layer 252. The swelling tape 250 may include the swelling particle in the substrate layer 251.

In detail, the swelling tape 250 may be completed by mixing a swelling particle with a raw material of the tape substrate to form a mixture of swelling particles mixed with the raw material, manufacturing a film of the mixture to form the substrate layer 251 (i.e., the swelling particles within the substrate layer 251), and applying an adhesive to the substrate layer 251 to form the adhesive layer 252 on the substrate layer 251. Because the swelling particle swells three-dimensionally in the substrate layer 251, a direction in which a swelling effect occurs may be maximized in a thickness direction of the swelling tape 250 by increasing a thickness of the swelling tape 250.

In the rechargeable battery 2 to which the swelling tape 250 is applied, the substrate layer 251 with the swelling particle may be in contact with the first separator 131, and the adhesive layer 252 may be attached to the outer uncoated portion 12c of the second electrode 12. In this case, the outer uncoated portion 12c may be in close contact (e.g., direct contact) with the inner surface of the case 20 to form an electrical connection.

Because the swelling particle included in the substrate layer 251 absorbs an electrolyte to swell within the rechargeable battery 2, a thickness of the substrate layer 251 may increase so that an entire thickness of the swelling tape 250 increases. For example, an expansion rate of the swelling tape 250 may be maximized.

The swelling particle may expand by absorbing the electrolyte. In this case, the swelling particle may expand in all three directions, so that the swelling tape 50 stably secures an increase in the thickness. Therefore, the outer uncoated portion 12c of the second electrode 12 may be in stable contact with the inner surface of the case 20 while receiving a swelling support force of the swelling tape 250. Therefore, an internal resistance of the rechargeable battery 2 may be stably reduced.

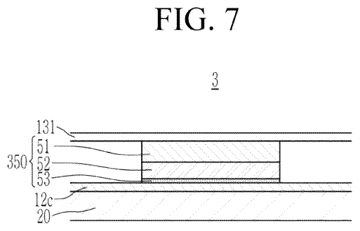

FIG. 7 is a cross-sectional view showing a stacking relationship between the first separator 131, a swelling tape, the outer uncoated portion 12c, and the case 20 of a rechargeable battery 3 according to still another embodiment of the present disclosure, enlarged in a planar state.

Referring to FIG. 7, in the rechargeable battery 3, a swelling tape 350 may include the substrate layer 51, the adhesive layer 52, and a swelling particle film 53. The swelling particle film 53 may be formed by coating a swelling particle on a surface of the adhesive layer 52, so the swelling particle film 53 may be between the adhesive layer 52 and the outer uncoated portion 12c (e.g., the swelling particle may be only in the swelling particle film 53 on the surface of the adhesive layer 52 and not within the adhesive layer 52).

The swelling tape 350 may be completed by forming the swelling particle film 53 by coating the swelling particle on the adhesive layer 52 while maintaining the substrate layer 51. In the swelling tape 350, the swelling particle film 53 may be formed on one surface of the adhesive layer 52, and because the swelling particle three-dimensionally swells at the one surface, a direction in which a swelling effect occurs may be maximized in a thickness direction of the swelling tape 350 by increasing a thickness of the swelling tape 350.

In the rechargeable battery 3 to which the swelling tape 350 is applied, the substrate layer 51 may be in contact with the first separator 131, and the swelling particle film 53 may be attached to the outer uncoated portion 12c of the second electrode 12. In this case, the outer uncoated portion 12c may be in close contact (e.g., direct contact) with the inner surface of the case 20 to form an electrical connection.

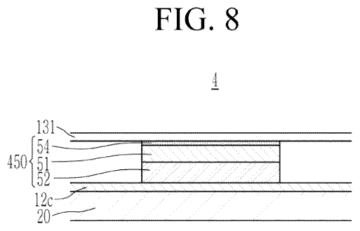

FIG. 8 is a cross-sectional view showing a stacking relationship between the first separator 131, a swelling tape, the outer uncoated portion 12c, and the case 20 of a rechargeable battery 4 according to still another embodiment of the present disclosure, enlarged in a planar state.

Referring to FIG. 8, in the rechargeable battery 4, a swelling tape 450 may include the substrate layer 51, the adhesive layer 52, and a swelling particle film 54. The swelling particle film 54 may be formed by coating a swelling particle on a surface of the substrate layer 51, so the swelling particle film 54 may be between the substrate layer 51 and the first separator 131.

The swelling tape 450 may be completed by coating the swelling particle on the substrate layer 51. For example, the swelling particle may be only in the swelling particle film 54 on the surface of the substrate layer 51 and not within either the substrate layer 51 or the adhesive layer 52 (e.g., so the adhesive layer 52 in FIG. 8 may be similar to the adhesive layer 252 in FIG. 6).

In the swelling tape 450, the swelling particle film 54 may be formed on one surface of the substrate layer 51, and because the swelling particle three-dimensionally swells at the one surface, a direction in which a swelling effect occurs may be maximized in a thickness direction of the swelling tape 450 by increasing a thickness of the swelling tape 450.

In the rechargeable battery 4 to which the swelling tape 450 is applied, the swelling particle film 54 may be in contact with the first separator 131, and the adhesive layer 52 may be attached to the outer uncoated portion 12c of the second electrode 12. In this case, the outer uncoated portion 12c may be in close contact with the inner surface of the case 20 to form an electrical connection.

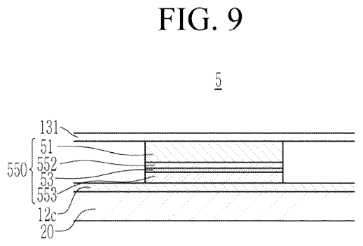

FIG. 9 is a cross-sectional view showing a stacking relationship between the first separator 131, a swelling tape, the outer uncoated portion 12c, and the case 20 of a rechargeable battery 5 according to yet another embodiment of the present disclosure, enlarged in a planar state.

Referring to FIG. 9, in the rechargeable battery 5, a swelling tape 550 may include the substrate layer 51, an adhesive layer 552, the swelling particle film 53, and an additional adhesive layer 553. The swelling particle film 53 may be formed by coating a swelling particle on a surface of the adhesive layer 552. The additional adhesive layer 553 may be formed by applying an adhesive to the swelling particle film 53. For example, the swelling particle film 53 may form an intermediate layer between the adhesive layer 552 and the additional adhesive layer 553.

The swelling tape 550 may be completed by further forming the additional adhesive layer 553 on the swelling particle film 53. For example, the swelling particle may be only in the swelling particle film 53 between surfaces of the adhesive layer 552 and the additional adhesive layer 553 and not within either of the adhesive layers 552 and 553 (e.g., the adhesive layer 552 in FIG. 9 may be similar to the adhesive layer 52 in FIG. 7).

In the swelling tape 550, the swelling particle film 53 may be formed between the adhesive layer 552 and the additional adhesive layer 553, and because the swelling particle three-dimensionally swells between the adhesive layer 552 and the additional adhesive layer 553, a direction in which a swelling effect occurs may be maximized in a thickness direction of the swelling tape 550 by increasing a thickness of the swelling tape 550.

In the rechargeable battery 5 to which the swelling tape 550 is applied, the substrate layer 51 may be in contact with the first separator 131, the adhesive layer 552 may be attached to the substrate layer 51, the swelling particle film 53 may be formed between the adhesive layer 552 and the additional adhesive layer 553, and the additional adhesive layer 553 may be attached to the outer uncoated portion 12c of the second electrode 12. In this case, the uncoated portion 12c may be in close contact (e.g., direct contact) with the inner surface of the case 20 to form an electrical connection.

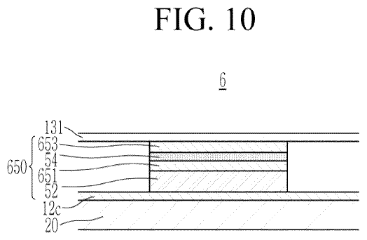

FIG. 10 is a cross-sectional view showing a stacking relationship between the first separator 131, a swelling tape, the outer uncoated portion 12c, and the case 20 of a rechargeable battery 6 according to still another embodiment of the present disclosure, enlarged in a planar state.

Referring to FIG. 10, in the rechargeable battery 6, the swelling tape 650 may include a substrate layer 651, the adhesive layer 52, the swelling particle film 54, and an additional substrate layer 653. The swelling particle film 54 may be formed by coating a swelling particle on a surface of the substrate layer 651. The additional substrate layer 653 may be formed by attaching a substrate to the swelling particle film 54. For example, the swelling particle film 54 may form an intermediate layer between the substrate layer 651 and the additional substrate layer 653.

The swelling tape 650 may be completed by coating the swelling particle on the substrate layer 651 to form the swelling particle film 54 and further forming the additional substrate layer 653 on the swelling particle film 54. For example, the swelling particle may be only in the swelling particle film 54 between surfaces of the substrate layer 651 and the additional substrate layer 653 and not within either of the substrate layers 651 and 653 (e.g., the substrate layer 651 in FIG. 10 may be similar to the substrate layer 51 in FIG. 8).

In the swelling tape 650, the swelling particle film 54 may be formed between the substrate layer 651 and the additional substrate layer 653, and because the swelling particle three-dimensionally swells between the substrate layer 651 and the additional substrate layer 653, a direction in which a swelling effect occurs may be maximized in a thickness direction of the swelling tape 650 by increasing a thickness of the swelling tape 650.

In the rechargeable battery 6 to which the swelling tape 650 is applied, the additional substrate layer 653 may be in contact with the first separator 131, the substrate layer 651 may be attached to the adhesive layer 52, the swelling particle film 54 may be formed between the substrate layer 651 and the additional substrate layer 653, and the adhesive layer 52 may be attached to the outer uncoated portion 12c of the second electrode 12. In this case, the outer uncoated portion 12c may be in close contact (e.g., direct contact) with the inner surface of the case 20 to form an electrical connection.

Hereinafter, various experimental examples to which the embodiments of the present disclosure are applied will be described with reference to Table 1.

TABLE 1

| | | | Swelling particle | | | | | Thickness | | |
|---|---|---|---|---|---|---|---|---|---|---|
| | Swelling tape | | | | Add'l | | | of | Adhesive | Amount |
| | Substrate | Adhesive | | d50 | amount | Addition position | | adhesive | strength | of |
| No. | layer | layer | Material | μm | vol % | Position | Embodiments | layer μm | gf/15 mm | swelling % |
| Comp. | PP | Acryl | — | — | 0 | — | General | 10 | 250 | <1 |
| Ex. | | adhesive | | | | | configuration | | | |
| Exp. | PP | Acryl | Acryl | 1 | 15 | Adhesive | Embodiment | 10 | 245 | 220 |
| Ex. 1 | | adhesive | polymer | | | layer | of FIG. 5 | | | |
| Exp. | PP | Acryl | Acryl | 5 | 15 | Adhesive | Embodiment | 11 | 230 | 280 |
| Ex. 2 | | adhesive | polymer | | | layer | of FIG. 5 | | | |
| Exp. | PP | Acryl | Acryl | 10 | 15 | Adhesive | Embodiment | 13 | 205 | 350 |
| Ex. 3 | | adhesive | polymer | | | layer | of FIG. 5 | | | |
| Exp. | PP | Acryl | Acryl | 15 | 15 | Adhesive | Embodiment | 18 | 190 | 390 |
| Ex. 4 | | adhesive | polymer | | | layer | of FIG. 5 | | | |
| Exp. | PP | Acryl | Acryl | 20 | 15 | Adhesive | Embodiment | 25 | 150 | 450 |
| Ex. 5 | | adhesive | polymer | | | layer | of FIG. 5 | | | |
| Exp. | PP | Acryl | Acryl | 30 | 15 | Adhesive | Embodiment | 36 | 115 | 500 |
| Ex. 6 | | adhesive | polymer | | | layer | of FIG. 5 | | | |
| Exp. | PP | Acryl | Acryl | 40 | 15 | Adhesive | Embodiment | 50 | 85 | 560 |
| Ex. 7 | | adhesive | polymer | | | layer | of FIG. 5 | | | |
| Exp. | PP | Acryl | Acryl | 5 | 5 | Adhesive | Embodiment | 10 | 245 | 230 |
| Ex. 8 | | adhesive | polymer | | | layer | of FIG. 5 | | | |
| Exp. | PP | Acryl | Acryl | 5 | 10 | Adhesive | Embodiment | 11 | 235 | 270 |
| Ex. 9 | | adhesive | polymer | | | layer | of FIG. 5 | | | |
| Exp. | PP | Acryl | Acryl | 5 | 20 | Adhesive | Embodiment | 17 | 220 | 360 |
| Ex. 10 | | adhesive | polymer | | | layer | of FIG. 5 | | | |
| Exp. | PP | Acryl | Acryl | 5 | 30 | Adhesive | Embodiment | 25 | 180 | 420 |
| Ex. 11 | | adhesive | polymer | | | layer | of FIG. 5 | | | |
| Exp. | PP | Acryl | Acryl | 5 | 50 | Adhesive | Embodiment | 61 | 110 | 500 |
| Ex. 12 | | adhesive | polymer | | | layer | of FIG. 5 | | | |
| Exp. | PP | Acryl | Acryl | 5 | 60 | Adhesive | Embodiment | 71 | 80 | 540 |
| Ex. 13 | | adhesive | polymer | | | layer | of FIG. 5 | | | |
| Exp. | PP | Acryl | Acryl | 5 | 15 | Substrate | Embodiment | 11 | 250 | 210 |
| Ex. 14 | | adhesive | polymer | | | layer | of FIG. 6 | | | |
| Exp. | PP | Acryl | Acryl | 5 | 15 | Surface | Embodiment | 11 | 40 | 300 |
| Ex. 15 | | adhesive | polymer | | | of | of FIG. 7 | | | |
| | | | | | | adhesive | | | | |
| | | | | | | layer | | | | |
| Exp. | PP | Acryl | Acryl | 5 | 15 | Surface | Embodiment | 11 | 250 | 300 |
| Ex. 16 | | adhesive | polymer | | | of | of FIG. 8 | | | |
| | | | | | | substrate | | | | |
| | | | | | | layer | | | | |
| Exp. | PP | Acryl | Acryl | 5 | 15 | Adhesive | Embodiment | 11 | 250 | 280 |
| Ex. 17 | | adhesive | polymer | | | interm. | of FIG. 9 | | | |
| | | | | | | Layer | | | | |
| Exp. | PP | Acryl | Acryl | 5 | 15 | Substrate | Embodiment | 11 | 250 | 220 |
| Ex. 18 | | adhesive | polymer | | | interm. | of FIG. 10 | | | |
| | | | | | | Layer | | | | |
| Exp. | PP | Acryl | Urethane | 5 | 15 | Adhesive | Embodiment | 11 | 240 | 360 |
| Ex. 19 | | adhesive | polymer | | | layer | of FIG. 5 | | | |
| Exp. | PP | Acryl | Silicon | 5 | 15 | Adhesive | Embodiment | 11 | 235 | 300 |
| Ex. 20 | | adhesive | polymer | | | layer | of FIG. 5 | | | |
| Exp. | PP | Rubber | Acryl | 5 | 15 | Adhesive | Embodiment | 11 | 300 | 310 |
| Ex. 21 | | adhesive | polymer | | | layer | of FIG. 5 | | | |
| Exp. | PP | Silicon | Acryl | 5 | 15 | Adhesive | Embodiment | 11 | 280 | 270 |
| Ex. 22 | | adhesive | polymer | | | layer | of FIG. 5 | | | |
| Exp. | PP | Polyolefin | Acryl | 5 | 15 | Adhesive | Embodiment | 11 | 340 | 330 |
| Ex. 23 | | hot melt | polymer | | | layer | of FIG. 5 | | | |
| | | adhesive | | | | | | | | |
| Exp. | PE | Acryl | Acryl | 5 | 15 | Adhesive | Embodiment | 11 | 230 | 320 |
| Ex. 24 | | adhesive | polymer | | | layer | of FIG. 5 | | | |
| Exp. | PET | Acryl | Acryl | 5 | 15 | Adhesive | Embodiment | 11 | 230 | 300 |
| Ex. 25 | | adhesive | polymer | | | layer | of FIG. 5 | | | |
| Exp. | PI | Acryl | Acryl | 5 | 15 | Adhesive | Embodiment | 11 | 230 | 300 |
| Ex. 26 | | adhesive | polymer | | | layer | of FIG. 5 | | | |
| Exp. | PVDF | Acryl | Acryl | 5 | 15 | Adhesive | Embodiment | 11 | 230 | 450 |
| Ex. 27 | | adhesive | polymer | | | layer | of FIG. 5 | | | |
| Exp. | Urethane | Acryl | Acryl | 5 | 15 | Adhesive | Embodiment | 11 | 230 | 470 |
| Ex. 28 | | adhesive | polymer | | | layer | of FIG. 5 | | | |

In the experimental examples 1 to 28, swelling tapes according to the configurations of the embodiments in FIGS. 1-10 were prepared to confirm respective swelling amounts thereof, and the materials and amounts of the swelling particles in each of the swelling tapes were varied in accordance with Table 1. The comparative example was prepared in the same manner as the experimental examples 1-28, with the exception that swelling particles were not used.

In the experimental examples 1 to 28, an adhesive solution was prepared so that a thickness of the tape substrate was 30 μm and a solid content of the adhesive solution was 10 wt %, based on the entire weight of the adhesive solution. A predetermined amount of the swelling particles was added to the adhesive solution (based on Table 1). The adhesive layer was produced by applying the adhesive solution to a gap of 100 μm and then volatilizing a solvent at 100° C.

The adhesive strength was a measured value obtained by attaching the swelling tape to an aluminum substrate having a thickness of 30 μm before immersion in an electrolyte, leaving the attached swelling tape with the aluminum substrate for 24 hours, and then peeling the swelling tape off in a T shape at a speed of 50 mm/min. The swelling amount refers to an amount of change before and after an electrolyte immersion test in a thickness direction.

In Table 1, the experimental examples 1 to 28 show a swelling amount of 210% to 560%. In the comparative example, the swelling amount is shown to be less than 1% in a swelling tape without swelling particles.

A volume change rate (i.e., the swelling amount) is good if the swelling amount is 200% or more, e.g., if the swelling amount is 300% or more. The swelling amount is good if the swelling amount is less than 500%. If the swelling amount is less than 200%, a large amount of the swelling particles has to be added to obtain the desired swelling effect, thereby deteriorating the adhesive strength of the adhesive layer and the mechanical characteristics of the substrate layer. If the swelling amount exceeds 500%, a strength of the swelling particles may decrease after the swelling so that a force pressing the outer uncoated portion 12c of the second electrode 12 decreases, thereby preventing or minimizing contact between the outer uncoated portion 12c and the inner surface of the case 20 and not reducing the internal resistance.

It may be seen that the swelling amount of the swelling tape in a case in which the swelling particle is used in the swelling tape is significantly different (i.e., larger), as compared with that of a case in which the swelling particle is not used in the swelling tape. Thus, the swelling tape of the embodiments to which the swelling particle is applied may absorb the electrolyte to maximize the expansion rate, and may stably secure a thickness increase effect.

By way of summation and review, a cylindrical rechargeable battery may include a swelling tape to fill an internal void. The swelling tape may be attached to an outermost layer of a jelly roll or an inner layer substrate of the jelly roll. The swelling tape may include a tape substrate and an adhesive layer. The tape substrate may absorb an electrolyte and swell, so that the tape substrate creates a wrinkle to increase a thickness thereof. As a result, the swollen swelling tape presses an outermost electrode substrate of the jelly roll to contact the can of the cylindrical rechargeable battery, so that an increase in an internal resistance may be suppressed.

However, if the tape substrate of the swelling tape is swollen, the wrinkle of the tape substrate may spread in a surface direction (rather than a thickness direction) depending on a structure and a pressure inside the rechargeable battery. In this case, a force applied to the outermost electrode substrate may decrease by an increase in a desired thickness. Therefore, an effect of reducing the internal resistance and filling a space may not be fully realized.

In contrast, embodiments of the present disclosure provide an electrode assembly that maximizes an expansion rate of a swelling tape and a rechargeable battery implementing the electrode assembly. That is, embodiments of the present disclosure provide a swelling tape with swelling particles on one surface of an electrode substrate of an electrode assembly (i.e., on an uncoated portion of an electrode) to absorb an electrolyte into the swelling tape, thereby maximize an expansion rate of the swelling tape. The swelling particles may expand by absorbing the electrolyte, thereby expanding three-dimensionally and stably securing a thickness increase effect. Therefore, an internal resistance of a rechargeable battery may be lowered because the swelling tape stably pressurizes the uncoated portion of an outermost electrode substrate.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode assembly, comprising:
a first electrode;
a first separator on the first electrode;
a second electrode on the first separator, the second electrode including an outer uncoated portion;
a second separator on the second electrode, the first electrode, the first separator, the second electrode, and the second separator being wound into a jelly roll shape, and the outer uncoated portion of the second electrode being at an outermost turn of the jelly roll shape; and
a swelling tape attached to at least one of opposite surfaces of the outer uncoated portion of the second electrode, the swelling tape including swelling particles.

2. The electrode assembly as claimed in claim 1, wherein the swelling tape is at one position or a plurality of positions along a wound circumferential direction of the electrode assembly.

3. The electrode assembly as claimed in claim 1, wherein the swelling tape includes a substrate layer and an adhesive layer, the swelling particles being included in the adhesive layer.

4. The electrode assembly as claimed in claim 3, wherein the substrate layer is in contact with the first separator, and the adhesive layer and the swelling particle are in contact with the outer uncoated portion of the second electrode.

5. The electrode assembly as claimed in claim 1, wherein the swelling tape includes a substrate layer and an adhesive layer, the swelling particles being included in the substrate layer.

6. The electrode assembly as claimed in claim 5, wherein the substrate layer and the swelling particles are in contact with the first separator, and the adhesive layer is in contact with the outer uncoated portion of the second electrode.

7. The electrode assembly as claimed in claim 1, wherein the swelling tape includes a substrate layer, an adhesive layer, and a swelling particle film on a surface of the adhesive layer.

8. The electrode assembly as claimed in claim 7, wherein the substrate layer is in contact with the first separator, and the swelling particle film is in contact with the outer uncoated portion of the second electrode.

9. The electrode assembly as claimed in claim 7, wherein the swelling tape further includes an additional adhesive layer on the swelling particle film.

10. The electrode assembly as claimed in claim 9, wherein the substrate layer is in contact with the first separator, the adhesive layer is in contact with the substrate layer, and the additional adhesive layer is in contact with the outer uncoated portion of the second electrode.

11. The electrode assembly as claimed in claim 1, wherein the swelling tape includes a substrate layer, an adhesive layer, and a swelling particle film coated on a surface of the substrate layer.

12. The electrode assembly as claimed in claim 11, wherein the swelling particle film is in contact with the first separator, and the adhesive layer is in contact with the outer uncoated portion of the second electrode.

13. The electrode assembly as claimed in claim 11, wherein the swelling tape further includes an additional substrate layer on the swelling particle film.

14. The electrode assembly as claimed in claim 13, wherein the additional substrate layer is in contact with the first separator, the substrate layer is in contact with the adhesive layer, and the adhesive layer is in contact with the outer uncoated portion of the second electrode.

15. The electrode assembly as claimed in claim 1, wherein the swelling tape includes a substrate layer and an adhesive layer, the substrate layer including at least one of polypropylene, polyethylene, polyimide, polyethylene terephthalate, polyvinylidene fluoride, and urethane.

16. The electrode assembly as claimed in claim 15, wherein the adhesive layer including at least one of an acryl adhesive, a rubber adhesive, a silicon adhesive, and a polyolefin hot melt adhesive.

17. The electrode assembly as claimed in claim 1, wherein the swelling particle includes at least one of an acryl polymer, a urethane polymer, and a silicon polymer.

18. The electrode assembly as claimed in claim 17, wherein the swelling tape includes a substrate layer and an adhesive layer, each of the swelling particles has a size of 1 μm to 40 μm, and the swelling particles are included in an amount of 5 vol % 60 vol % of the adhesive layer.

19. The electrode assembly as claimed in claim 18, wherein a thickness of the adhesive layer is 10 μm to 71 μm.

20. A rechargeable battery, comprising:
the electrode assembly as claimed in claim 1; and
a case that accommodates the electrode assembly, the outer uncoated portion of the second electrode being electrically connected to an inner surface of the case.
